(19) United States
(12) Patent Application Publication
(10) Pub. No.: US 2007/0133539 A1
(43) Pub. Date: Jun. 14, 2007

(54) Routing apparatus for supporting IPv6 anycast service and method thereof

(75) Inventors: Yoo Hwa Kang, Daegu-city (KR); Tae Il Kim, Daejeon-city (KR); Hae Won Jung, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/455,590

(22) Filed: Jun. 16, 2006

(30) Foreign Application Priority Data
Dec. 8, 2005 (KR) 10-2005-0119468

(51) Int. Cl. H04L 12/56

(52) U.S. Cl. 370/392; 370/401

(57) ABSTRACT

A routing apparatus for supporting an IPv6 anycast service and a method thereof are provided. The anycast routing apparatus includes: a receiving unit receiving a neighbor discovery protocol (NDP) message; a routing entry unit adding or deleting a host route for an IPv6 anycast address and a neighbor entry for the IPv6 anycast address according to the NDP message, if the NDP message includes the IPv6 anycast address; and an anycast address manager managing the host route or the neighbor entry according to a neighbor unreachability detection (NUD) process. Accordingly, an IPv6 anycast address can be transmitted between a host and a router, thereby configuring routing information effectively.

### CROSS-REFERENCE TO RELATED PATENT APPLICATION

This application claims the benefit of Korean Patent Application No. 10-2005-0119468, filed on Dec. 8, 2005, in the Korean Intellectual Property Office, the disclosure of which is incorporated herein in its entirety by reference.

### BACKGROUND OF THE INVENTION

1. Field of the Invention

The present invention relates to a routing apparatus for supporting an IPv6 anycast service and a method thereof.

2. Description of the Related Art

IP version 6 (IPv6) defines a unicast address, a multicast address, and an anycast address. One expected use of anycast addresses is to identify a group of routers belonging to an internet providing service. Some other possible uses are to identify a group of routers attached to a particular subnet, or a group of routers providing entry into a particular routing domain.

RFC 3513 is a RFC standard. According to the RFC 3513 standard, an anycast address must not be used as the source address of an IPv6 packet, and must not be assigned to an IPv6 host, that is, it may be assigned to an IPv6 router only.

However, if an anycast address is assigned to a router only, an anycast service is limited to a routing service. If an anycast address is assigned to a group of servers providing various services including the routing service, the anycast address can be used for more types of services.

When an anycast address is assigned to a server, if a router needs to configure a host route for the anycast address, the server and the router have to be able to communicate with each other to transmit the anycast address.

As for a method in which the router configures the host route for the anycast address, a static route method and a dynamic route method have been proposed.

However, once the host route for the anycast address is created by the router using the static route method, the host route for the anycast address is permanently assigned to the router even when the anycast address is not assigned to the host. In this case, if an anycast address packet is routed to the host when the anycast address is not assigned to the host, the host cannot provide a requested anycast service.

The host has to transmit anycast address information to the router in order to dynamically indicate an anycast service state. When a routing protocol is required to transfer the information, the routing protocol has to be operated in the host.

When the routing protocol is not required, the host may send information on the anycast address periodically through the multicast, which increases traffic.

Similarly to the unicast address, a packet is forwarded by configuring an IPv6 anycast address in the form of a routing table, which may affect all of a plurality of internet routing tables. In addition, there is no method of transmitting the IPv6 anycast address assigned to the host to the router. For this reason, use of the IPv6 anycast address is restricted to the routing service only. To address these problems, a method is required in which the host can transmit information on the anycast address to the router dynamically without having to use the routing protocol.

### SUMMARY OF THE INVENTION

The present invention provides an apparatus and method for transmitting and managing information on an IPv6 address dynamically by using a neighbor discovery protocol (NDP), conventionally used between a host and a router.

The present invention also provides an apparatus and method for expanding the use of an IPv6 anycast address from a router only to a server.

The present invention also provides a method of transmitting an IPv6 anycast address between a host and a router, and an apparatus and method for configuring and managing a host route for an IPv6 anycast address by a router, so that the IPv6 anycast address can be assigned to a group of servers providing various services.

According to an aspect of the present invention, there is provided an anycast routing apparatus comprising: a receiving unit receiving a neighbor discovery protocol (NDP) message; a routing entry unit adding or deleting a host route for an IPv6 anycast address and a neighbor entry for the IPv6 anycast address according to the NDP message, if the NDP message comprises the IPv6 anycast address; and an anycast address manager managing the host route or the neighbor entry according to a neighbor unreachability detection (NUD) process.

In the aforementioned aspect of the present invention, the NDP message may comprise an option field indicating information on creation or deletion of the IPv6 anycast address and a router solicitation (RS) message comprising an information field of the IPv6 anycast address.

In addition, the NDP message may comprise a neighbor advertisement (NA) message having an option field indicating information on creation or deletion of the IPv6 anycast address.

According to another aspect of the present invention, there is provided an anycast routing method comprising: (a) receiving an NDP message; (b) adding or deleting a host route for an IPv6 anycast address and a neighbor entry for the IPv6 anycast address according to the NDP message, if the received NDP message comprises the IPv6 anycast address; and (c) managing the host route or the neighbor entry according to a NUD process in which a NS message is transmitted to all IPv6 anycast addresses within a network and a NA message is received in response to the NS message.

### BRIEF DESCRIPTION OF THE DRAWINGS

The above and other features and advantages of the present invention will become more apparent by describing in detail exemplary embodiments thereof with reference to the attached drawings in which:

FIG. 1 shows a reserved subnet anycast address format defined using the IETF RFC 2526 standard;

FIG. 2 shows an internal structure of an anycast routing apparatus according to an embodiment of the present invention;

FIG. 3 shows how an IPv6 anycast address is transmitted from a host to a router and how the router performs anycast routing, according to an embodiment of the present invention;

FIG. 4 shows a router solicitation (RS) message format according to an embodiment of the present invention;

FIG. 5 shows a neighbor advertisement (NA) message format according to an embodiment of the present invention;

FIG. 6 is a flowchart illustrating an anycast routing method according to an embodiment of the present invention; and

FIG. 7 is a flowchart illustrating a neighbor unreachability detection (NUD) process which is periodically performed by the anycast address manager of FIG. 2.

### DETAILED DESCRIPTION OF THE INVENTION

Hereinafter, the present invention will be described in detail by explaining exemplary embodiments of the invention with reference to the attached drawings. Like reference numerals denote like elements in the drawings. If related well-known operations or configurations are determined to be unnecessary in explaining the present invention, detailed descriptions thereof will be omitted.

FIG. 1 shows a reserved subnet anycast address format defined using the IETF RFC 2526 standard.

A subnet prefix in an anycast address identifies a specific link. An anycast ID is set to a decimal number 126, which is currently reserved for a Mobile IPv6 Home-Agents anycast address.

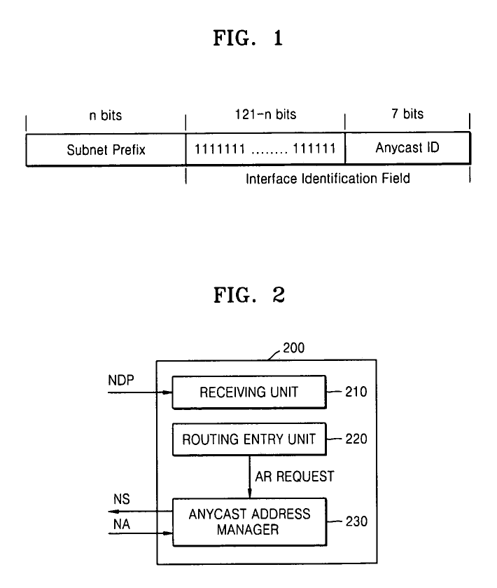

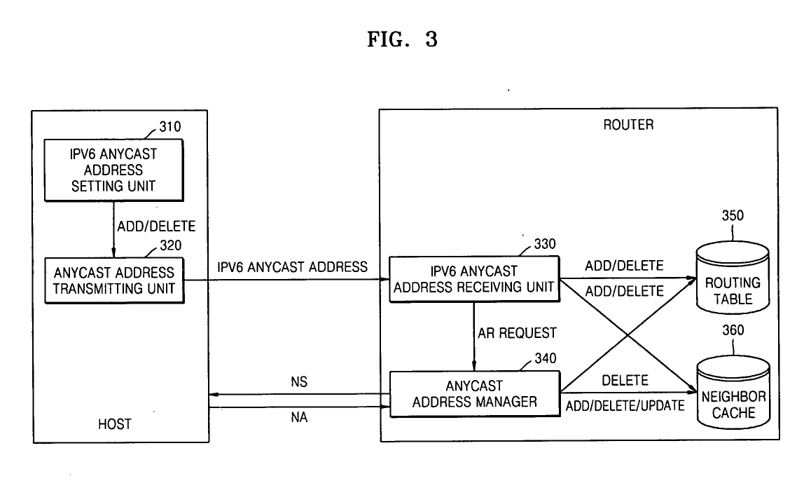

FIG. 2 shows an internal structure of an anycast routing apparatus according to an embodiment of the present invention.

An anycast service assigns an anycast address to a service group, and provides effective routing for a packet to be delivered to the anycast address.

In the IPv6 standard, an anycast address format is the same as a unicast address format. Thus, as in the case of a unicast address, when the anycast address is routed, the router forwards a packet by configuring the anycast address in the form of a routing table.

To this end, the anycast routing apparatus receives an IPv6 anycast address assigned to a host through a neighbor discovery protocol (NDP) message, configures a host route for the IPv6 anycast address and a neighbor entry for the IPv6 anycast address. Thereafter, the anycast routing apparatus periodically performs a neighbor unreachability detection (NUD) process to manage changes in the IPv6 anycast address, thereby managing the host route and the neighbor entry.

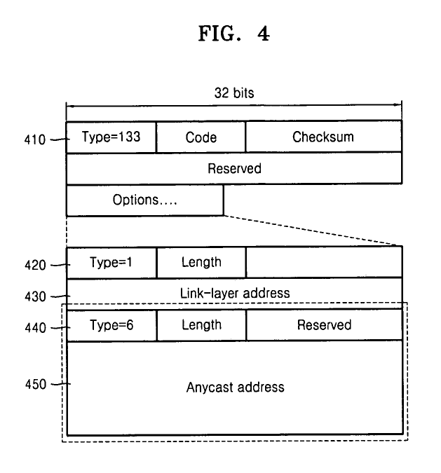

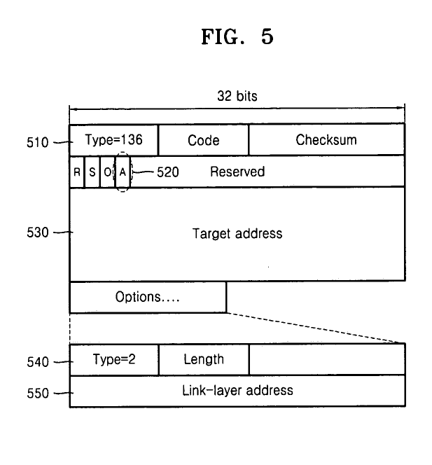

Specifically, a receiving unit 210 receives the NDP message. The NDP message may be a router solicitation (RS) message or a neighbor advertisement (NA) message. The RS and NA messages will be described in detail later with reference to FIGS. 4 and 5.

If the received NDP message includes information on the IPv6 anycast address, and the IPv6 anycast address is added to or deleted from the host, a routing entry unit 220 adds or deletes the host route for the IPv6 anycast address and the neighbor entry for the IPv6 anycast address, according to the NDP message.

In an embodiment of the present invention, if it is determined that the IPv6 anycast address is created by the host after the routing entry unit 220 receives the NDP message including the IPv6 anycast address, the routing entry unit 220 creates a new host route.

If the IPv6 anycast address included in the received NDP message has a link layer address, the neighbor entry for the IPv6 anycast address is newly added. If the IPv6 anycast address does not have a link layer address, an address resolution (AR) request is sent to an anycast address manager 230.

When the host creates or deletes the IPv6 anycast address after the NDP message is received, the routing entry unit 220 stores and manages only the host route for the IPv6 anycast address and the neighbor entry for the IPv6 anycast address by using an additional IPv6 anycast address different from an IPv6 unicast address.

Also, the routing entry unit 220 forwards a packet to hosts which transmit NDP messages including the IPv6 anycast address, according to a host route included in an IPv6 anycast address list or an IPv6 anycast address included in the neighbor entry.

Up to now, no method has existed for transmitting the IPv6 anycast address assigned to the host to the router. For this reason, use of the IPV6 anycast address is restricted to a routing service only.

However, according to an embodiment of the present invention, a user can access the nearest server by allocating the IPv6 anycast address to a group of servers providing various services such as voice over internet protocol (VOIP), internet protocol television (IPTV), video on demand (VOD), and domain name service (DNS).

If the NA message fails to be received after the NUD process is performed in response to the AR request of the routing entry unit 220, the anycast address manager 230 does not create a neighbor entry but deletes a host route for the pre-created IPv6 anycast address.

In another embodiment of the present invention, if it is determined that the IPv6 anycast address is deleted by the host after the routing entry unit 220 receives the NDP message including the IPv6 anycast address, the routing entry unit 220 deletes the host route for the IPv6 anycast address and the neighbor entry for the IPv6 anycast address.

The anycast address manager 230 periodically transmits a neighbor solicitation (NS) message to all IPv6 anycast addresses within a network, and performs the NUD process to receive the NA message in response to the NS message.

In response to the NS message transmitted from the anycast address manager 230, if the NS message is received within a predetermined time period, the neighbor entry is updated based on changes in the link layer address included in the NA message. If the NA message fails to be received within the predetermined time period, the host route for the IPv6 anycast address and the neighbor entry for the IPv6 anycast address included in the NS message, which are stored in the routing entry unit 220, are deleted.

FIG. 3 shows how an IPv6 anycast address is transmitted from a host to a router and how the router performs anycast routing, according to an embodiment of the present invention.

An IPv6 anycast address setting unit 310 creates or deletes the IPv6 anycast address in/from the host. An anycast address transmitting unit 320 configures an NDP message using information on the IPv6 anycast address created or deleted by the IPv6 anycast address setting unit 310, and transmits the message through a network. The NDP message may be an RS message or a NA message.

An IPv6 anycast address receiving unit 330 receives the NDP message transmitted from the host. Then, if the NDP message indicates that information on the IPv6 anycast address is created or deleted, a host route is added or deleted to/from a routing table 350, and a neighbor entry is added or deleted to/from a neighbor cache 360.

If the IPv6 anycast address included in the NDP message does not have a link layer address, an AR request is sent to an anycast address manager 340. Thereafter, the anycast address manager 340 adds or updates a neighbor entry for the IPv6 anycast address to the neighbor cache 360 when the NA message is received, and deletes the neighbor entry and host router when the NA message is not received.

The anycast address receiving unit 330 transmits a NS message to all IPv6 anycast addresses within a network periodically using a timer, and performs a NUD process for receiving the NA message. As a result, a host route included in the routing table 350 is deleted, or a neighbor entry included in the neighbor cache 360 is deleted or updated.

FIG. 4 shows an RS message format according to an embodiment of the present invention.

An RS message is one of a plurality of ICMPv6 packet types used in a neighbor discovery protocol (NDP) message. In general, the RS message cannot be used to deliver information on an IPv6 anycast address. However, when the IPv6 anycast address is assigned to a host interface, the IPv6 anycast address may be optionally added to the RS message so as to deliver the information on the IPv6 anycast address to the router. Since five types of options are defined in the NDP message, in an embodiment of the present invention, an option type value 440 of “6” is added in the IPv6 anycast address.

The RS message includes a message type 410 which indicates a RS message type 133, a code which is used to classify the message according to the message type 410, a checksum, and options.

The RS message may include a link layer address 430 of a sender using the options. In addition, the RS message may include an IPv6 anycast address 450 by adding an option field 440 which contains information on creation or deletion of the IPv6 anycast address. The new option type 440 may be added in the form of TLV, so that a router which cannot use the options of the IPv6 anycast address can communicate by ignoring the options.

FIG. 5 shows a NA message format according to an embodiment of the present invention.

The NA message includes a message type 510 of “136” and a target IPv6 address 530. Additionally, the NA message may include a link layer address 550 of a target with an option type 540 of “2”.

A host may transmit an IPv6 anycast address along with the target IPv6 address 530 by using the NA message. In this case, the link layer address 550 for the IPv6 anycast address may be additionally transmitted along with the link layer address option 540.

The NA message includes an option field which indicates information on creation or deletion of the IPv6 anycast address. In other words, when the NA message including the IPv6 anycast address is transmitted, a bit A 520 is followed by bits R, S, and 0 to indicate that it is an anycast address.

A 520 can be comprised of 2

bits so as to be used to assign and delete the IPv6 anycast address. The bit A 520 may be added to the existing NA message to transmit the IPv6 anycast address.

Since the bit A 520 is added to a reserved field, the bit A 520 is ignored if a receiving end cannot use the bit A 520. Thus, the NA message can be used for transmitting the IPv6 anycast address regardless of the capability of the receiving end.

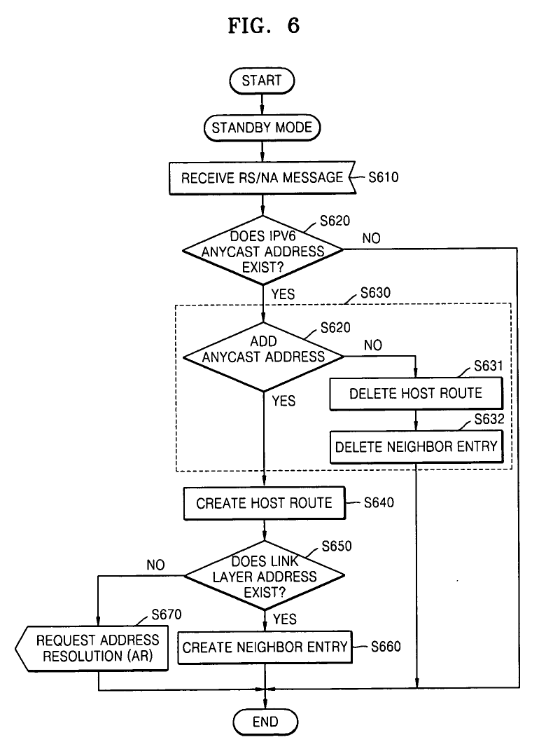

FIG. 6 is a flowchart illustrating an anycast routing method according to an embodiment of the present invention.

A RS message or a NA message is received as an NDP message (operation S610). It is checked whether an IPv6 anycast address is included in the received RS message or NA message. If an IPv6 anycast address is not included therein, the process is ended.

If an IPv6 anycast address is included therein, and if the received RS message or NA message includes information indicating that the IPv6 anycast address is created, a host route for the IPv6 anycast address and a neighbor entry for the IPv6 anycast address are added (operations S640 to S670). If the received RS message or NA message includes information indicating that the IPv6 anycast address is deleted, the host route for the IPv6 anycast address and the neighbor entry for the IPv6 anycast address are deleted (operations S631 and S632).

Specifically, when the IPv6 anycast address is created, the host route is created (operation S640). Thereafter, it is checked whether a link layer address exists in the RS message or NA message in order to add a neighbor entry (operation S650).

If a link layer address exists, a neighbor entry is created (operation S660). Otherwise, an AR is requested (operation S670). If there is a response to the RS message, a neighbor entry is created to be added. Otherwise, the host route for the IPv6 anycast address and the neighbor entry for the IPv6 anycast address included in the RS message or the NA message are deleted.

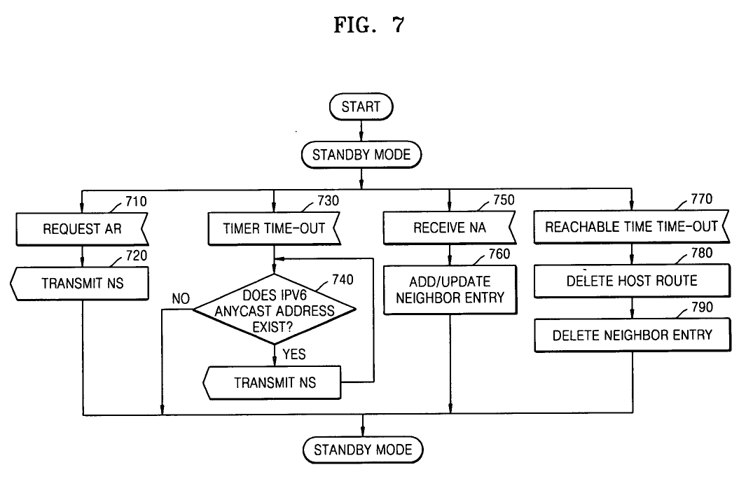

FIG. 7 is a flowchart illustrating a NUD process that is periodically performed by the anycast address manager 230 of FIG. 2.

When an AR request is received from the routing entry unit 220 of FIG. 2 (operation 710), the anycast address manager 230 of FIG. 2 transmits a NS message for a corresponding IPv6 anycast address to all IPv6 anycast addresses within a network (operation 720). If a NA message is received in response to the NS message (operation 750), a new neighbor entry is added to a neighbor cache (operation 760).

A router periodically transmits the NS message to all of the IPv6 anycast addresses (operation 740The IPv6 anycast addresses are managed by setting a timer (operation 730). If a NA message is received in response to the NS message which is transmitted to all of the IPv6 anycast addresses to perform the NUD process periodically (operation 750), a corresponding neighbor entry is updated when a link layer address included in the NA message is modified (operation 760).

When a reachable timer times out without any response to the NS message in the NUD process (operation 770), host routes for an IPv6 anycast address are deleted if no response is received from the IPv6 anycast address (operation 780). Likewise, neighbor entries for an IPv6 anycast address are deleted if no response is received from the IPv6 anycast address (operation 790).

Accordingly, in an embodiment of the present invention, an additional protocol is not required since an IPv6 anycast address assigned to a host is transmitted to a router by using a neighbor discovery protocol (NDP) message. The NDP message is used to transmit the IPv6 anycast address to the router, and is used to add an anycast address option to a router solicitation (RS) message or add a bit A in a neighbor advertisement (NA) message without having to modifying an NDP message format, thereby communicating with a router which cannot use the IPv6 anycast address.

In addition, the router periodically performs a neighbor unreachablility detection (NUD) process to manage changes in an IPv6 anycast address of a host. Further, information on forwarding can be correctly configured in advance by managing a routing table containing the IPv6 anycast address along with information on a neighbor cache.

In addition, since the IPv6 anycast address can be assigned to a group of servers providing various services, a user can access the nearest server by allocating the IPv6 anycast address to the group of servers providing various services such as VOIP, IPTV, VOD, and DNS.

Meanwhile, the embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An anycast routing apparatus comprising:
a receiving unit receiving a neighbor discovery protocol (NDP) message;
a routing entry unit adding or deleting a host route for an IPv6 anycast address and a neighbor entry for the IPv6 anycast address according to the NDP message, if the NDP message comprises the IPv6 anycast address; and
an anycast address manager managing the host route or the neighbor entry according to a neighbor unreachability detection (NUD) process.

2. The apparatus of claim 1, wherein the NDP message comprises an option field indicating information on creation or deletion of the IPv6 anycast address and a router solicitation (RS) message comprising an information field of the IPv6 anycast address.

3. The apparatus of claim 1, wherein the NDP message comprises a neighbor advertisement (NA) message having an option field indicating information on creation or deletion of the IPv6 anycast address.

4. The apparatus of claim 1, wherein the routing entry unit sends an address resolution (AR) request to the anycast address manager, if a link layer address is not included in the IPv6 anycast address, and
deletes the host route for the IPv6 anycast address and the neighbor entry for the IPv6 anycast address, if a NA message fails to be received when the AR is requested.

5. The apparatus of claim 1, wherein the anycast address manager periodically transmits a neighbor solicitation (NS) message to all IPv6 anycast addresses within a network, updates the neighbor entry according to changes in a link layer address included in the NA message, if the NA message is received within a predetermined time period in response to the NS message, and
deletes the host route for the IPv6 anycast address and the neighbor entry for the IPv6 anycast address included in the NS message, if the NA message fails to be received within the predetermined time period.

6. The apparatus of claim 1, wherein the routing entry unit forwards a packet to hosts which receive the NDP message comprising the IPv6 anycast address, according to the IPv6 anycast address included in the host route or the neighbor entry.

7. The apparatus of claim 1, wherein the routing entry unit comprises an IPv6 anycast address list to store and manage only the host route for an IPv6 anycast address and the neighbor entry for the IPv6 anycast address, if the received NDP message comprises information on the IPv6 anycast address.

8. The apparatus of claim 6, wherein each of the hosts comprises an internet protocol television (IPTV) server, a video on demand (VOD) server, and a soft switch.

9. An anycast routing method comprising:
(a) receiving an NDP message;
(b) adding or deleting a host route for an IPv6 anycast address and a neighbor entry for the IPv6 anycast address according to the NDP message, if the received NDP message comprises the IPv6 anycast address; and
(c) managing the host route or the neighbor entry according to a NUD process in which a NS message is transmitted to all IPv6 anycast addresses within a network and a NA message is received in response to the NS message.

10. The method of claim 9, wherein the NDP message comprises an option field indicating information on creation or deletion of the IPv6 anycast address and a RS message comprising an information field of the IPv6 anycast address.

11. The method of claim 9, wherein the NDP message comprises a NA message having an option field indicating information on creation or deletion of the IPv6 anycast address.

12. The method of claim 9, wherein (b) comprises:
requesting an AR if a link layer address is not included in the IPv6 anycast address;
sending a NS message to all IPv6 anycast addresses when the AR is requested, and
deleting the host route for the IPv6 anycast address and the neighbor entry for the IPv6 anycast address, if a NA message fails to be received in response to the NS message.

13. The method of claim 9, wherein (c) comprises:
periodically transmitting a NS message to all IPv6 anycast addresses within a network;
updating the neighbor entry according to changes in a link layer address included in the NA message, if the NA message is received within a predetermined time period in response to the NS message; and
deleting the host route for the IPv6 anycast address and the neighbor entry for the IPv6 anycast address included in the NS message, if the NA message fails to be received within the predetermined time period.

14. The method of claim 9, further comprising:
(d) forwarding a packet to hosts which receive the NDP message comprising the IPv6 anycast address, according to the IPv6 anycast address included in the host route or the neighbor entry.
